(19) United States
(12) Patent Application Publication
(10) Pub. No.: US 2015/0067558 A1
(43) Pub. Date: Mar. 5, 2015

(54) COMMUNICATION DEVICE AND METHOD USING EDITABLE VISUAL OBJECTS

(71) Applicant: Electronics and Telecommunications Research Institute, Daejeon (KR)

(72) Inventors: Sang-Hyun JOO, Daejeon (KR); Jae-Sook CHEONG, Daejeon (KR); Ji-Won LEE, Daejeon (KR); Si-Hwan JANG, Seoul (KR)

(21) Appl. No.: 14/474,044

(22) Filed: Aug. 29, 2014

(30) Foreign Application Priority Data
Sep. 3, 2013 (KR) 10-2013-0105330
Jan. 2, 2014 (KR) 10-2014-0000328

(51) Int. Cl. G06F 3/0484; G06K 9/00; G06F 17/27; G10L 15/26; G06F 9/44

(52) U.S. Cl. CPC G06F 3/0484; G10L 15/265; G06F 9/4448; G06F 17/275; G06K 9/00221; G06K 9/00389
USPC 715/765

(57) ABSTRACT

A communication device and method are disclosed. The communication device includes an intention input unit, a visual object processing unit, and a message management unit. The intention input unit receives a user's intention through an interface. The visual object processing unit outputs a recommended visual object related to the user's intention to the interface, and generates the metadata of an edited visual object when the user edits the recommended visual object through the interface. The message management unit sends a message, including the generated metadata of the visual object, to a counterpart terminal.

### CROSS-REFERENCE TO RELATED APPLICATIONS

This application claims the benefit of Korean Patent Application Nos. 10-2013-0105330 and 10-2014-0000328, filed Sep. 3, 2013, and Jan. 2, 2014, respectively, which is hereby incorporated by reference in its entirety into this application.

### BACKGROUND OF THE INVENTION

1. Technical Field

The present invention relates generally to a communication device and method using editable visual objects and, more particularly, to digital communication technology that enables users to freely edit and use visual objects according to their intentions.

2. Description of the Related Art

In general, online communication using visual objects is performed in such a manner that a user selects a visual object from a pool of predetermined visual objects, such as emoticons and flashcons, and sends the selected visual object to a counterpart. Such communication using visual objects functions to break through the limitations of text communication and thus enable communication between people having different languages or cultures.

Korean Patent Application Publication No. 10-2013-0049416 discloses a method of providing an instant messaging service using dynamic emoticons, and a mobile terminal for executing the method. However, conventional communication techniques, such as the disclosed method, are limited in terms of the delivery of precise intentions desired by users because only visual objects determined by a developer can be selected, and have difficulty managing corresponding data due to an increase in a pool of visual objects. Furthermore, in conventional communication platforms using visual objects, various editing functions, such as the resizing, rotation and inversion of visual objects, cannot be used, and only previously stored visual objects must be used. In particular, there is a disadvantage in that an excessively long time is required to search for a desired visual object when the number of visual objects is large. Furthermore, a conventional technique for recommending visual objects preferred by users is limited in that only the frequency or history of use of a visual object selected by a user is provided.

### SUMMARY OF THE INVENTION

Accordingly, the present invention has been made keeping in mind the above problems occurring in the conventional art, and an object of the present invention is to provide an apparatus and method that are capable of recommending visual objects suitable for situations by recognizing the visual object use patterns, text, voice and images of users and also enable users to freely edit visual objects according to their intentions and perform communication using the edited visual objects.

In accordance with an aspect of the present invention, there is provided a communication device, including an intention input unit configured to receive a user's intention through an interface; a visual object processing unit configured to output a recommended visual object related to the user's intention to the interface, and to generate the metadata of an edited visual object when the user edits the recommended visual object through the interface; and a message management unit configured to send a message, including the generated metadata of the visual object, to a counterpart terminal.

The intention input unit may receive the user's intention in at least one of text, voice, touch and image forms through the interface.

The visual object processing unit may include an intention analysis unit configured to analyze the received user's intention; and a visual object recommendation unit configured to search a visual object database for the recommended visual object based on results of the analysis of the user's intention, and to output the recommended visual object to the interface.

The intention analysis unit may include a text conversion unit configured to convert a voice into text when the user's intention is received in a voice form; and a keyword extraction unit configured to extract a keyword by analyzing text when the user's intention is received in a text form or when the voice is converted into the text by the text conversion unit.

The intention analysis unit may further include a multi-language conversion unit configured to convert the extracted keyword into a predetermined language when the extracted keyword does not correspond to the predetermined language.

The intention analysis unit may include an image recognition unit configured to extract information about the recommended visual object by recognizing a received image when the user's intention is received in an image form.

The communication device may further include an interface unit configured to output the interface to a terminal of the user, and to output a process of the recommended visual object being edited to the interface in response to an editing operation while the user performs the editing operation on the interface.

The communication device may further include a database management unit configured to store the metadata in a visual object database when the metadata of the visual object is generated.

The database management unit may send synchronization information to a communication server when a change is generated in the visual object database, may receive the synchronization information of the editable visual object from the communication server, and may incorporate the received synchronization information into the visual object database.

In accordance with another aspect of the present invention, there is provided a communication method, including receiving a user's intention through an interface; outputting a recommended visual object related to the user's intention to the interface; generating metadata of an edited visual object when the user edits the recommended visual object through the interface; and sending a message, including the generated metadata of the visual object, to a counterpart terminal

The communication method may further include analyzing the received user's intention when the user's intention is received; and searching a visual object database for the recommended visual object based on results of the analysis of the user's intention.

Analyzing the received user's intention may include determining a type of the received user's intention; converting a voice into text if, as a result of the determination, it is determined that the type of received user's intention is a voice; and extracting a keyword by analyzing text if, as a result of the determination, it is determined that the type of received user's intention is text or when the voice is converted into the text upon converting the voice into the text.

Analyzing the received user's intention may include converting the extracted keyword into a predetermined language when the extracted keyword does not correspond to the predetermined language.

Analyzing the received user's intention may include extracting information about the recommended visual object by recognizing a received image if, as a result of the determination, it is determined that the type of received user's intention is the image.

The communication method may further include outputting the interface to a terminal of the user; and outputting a process of the recommended visual object being edited to the interface in response to an editing operation while the user performs the editing operation in the interface.

The communication method may further include storing the metadata in a visual object database when the metadata of the visual object is generated.

The communication method may further include sending synchronization information to a communication server when a change is generated in the visual object database; receiving the synchronization information of the editable visual object from the communication server; and incorporating the received synchronization information into the visual object database.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates the configuration of a communication system according to an embodiment of the present invention;

FIG. 2 is a block diagram of a communication device according to an embodiment of the present invention;

FIG. 3 is a detailed block diagram of the visual object processing unit of the communication device of FIG. 2;

FIG. 4 is a detailed block diagram of the intention analysis unit of the visual object processing unit of FIG. 3;

FIG. 5 is a detailed block diagram of the database management unit of the communication device of FIG. 2;

FIG. 6 is a detailed block diagram of the message management unit of the communication device of FIG. 2;

FIG. 7 is a block diagram of a communication server according to an embodiment of the present invention;

FIG. 8 is a flowchart illustrating a communication method according to an embodiment of the present invention; and

FIG. 9 is a detailed flowchart illustrating the intention analysis step of the communication method of FIG. 8.

### DESCRIPTION OF THE PREFERRED EMBODIMENTS

Reference now should be made to the drawings, throughout which the same reference numerals are used to designate the same or similar components.

Embodiments of a digital communication device and method using editable visual objects are described in detail below with reference to the accompanying drawings.

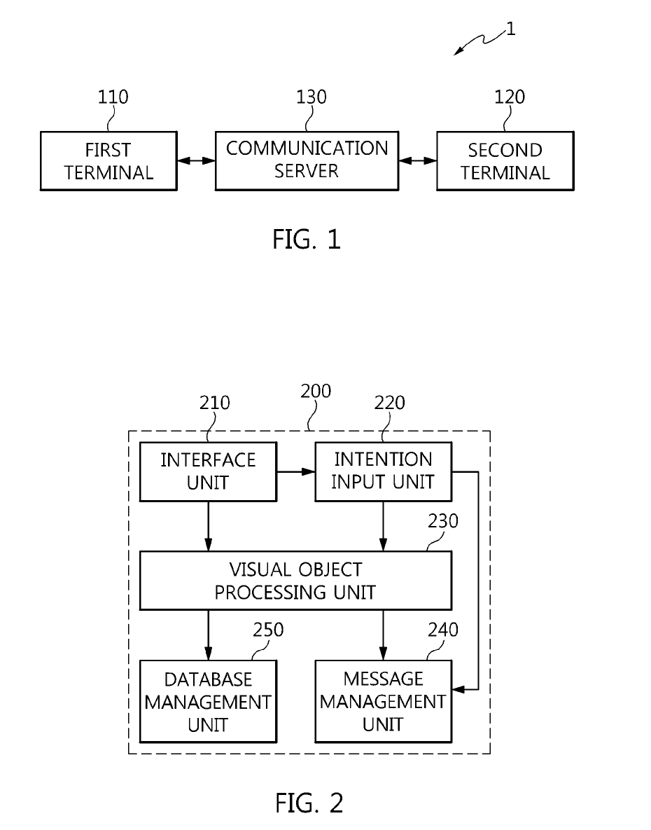

FIG. 1 illustrates the configuration of a communication system according to an embodiment of the present invention.

Referring to FIG. 1, the communication system 1 may include a plurality of user terminals 110 and 120, and a communication server 130.

As illustrated in FIG. 1, the user terminals 110 and 120 may send and receive various types of messages via the communication server 130. The user terminals 110 and 120 may be mobile terminals, such as smart phones or smart pads, or terminals, such as laptop computers or desktop personal computers (PCs).

Furthermore, communication devices configured to enable users to perform visual communication with each other may be mounted on the first terminal 110 and the second terminal 120. In this case, the communication device according to this embodiment of the present invention may be mounted on only one of the first terminal 110 and the second terminal 120.

In the following description, it is assumed for ease of description that the communication device is mounted on the first terminal 110, and the first terminal 110 is described. In contrast, if the communication device is mounted on the second terminal 120, the second terminal 120 may also perform functions to be described in detail later.

The first terminal 110 may enable a user to generate various editable visual objects through the communication device and to generate messages using the generated editable visual objects. The first terminal 110 may send the generated messages to the second terminal 120 through the communication server 130.

The first terminal 110 may receive a user's intention, and may recommend a visual object to be edited by the user. When the user edits the recommended visual object, the first terminal 110 may send a message including the edited visual object to the second terminal 120.

For this purpose, the first terminal 110 may provide an interface so that the user may easily input his or her intention and edit the recommended visual object. Furthermore, the first terminal 110 supports the user so that the user may input his or her intention using various methods, such as text, voice and an image, through the interface.

For example, the first terminal 110 may output a text entry box operative to enable a user to enter his or her intention in text to the interface. Alternatively, the first terminal 110 may output a voice input object, such as an icon having a microphone shape, so that a user may input his or her voice. When the user selects the voice input object, the first terminal 110 may receive the voice from the user by controlling a microphone mounted on the first terminal 110 or associated with the outside. Alternatively, the first terminal 110 may output an image input object, such as an icon having a camera shape, so that a user may input an image. When the user selects the image input object, the first terminal 110 may receive a face image of the user or an image of a hand gesture from the user by controlling an image capture module.

Furthermore, when a user's intention is received, the first terminal 110 may recommend an editable visual object, related to the intention, to the user. When the user edits the editable visual object, the first terminal 110 may generate a new editable visual object based on information about the edit, may manage the new editable visual object, may generate a message, including the new editable visual object, along with conversational content to be transferred from the user to a counterpart, and may send the message to the communication server 130.

Furthermore, the first terminal 110 may manage a database for managing editable visual objects in synchronization with the communication server 120 in real time so that the newest data is stored in the database.

When a message to be transmitted to the second terminal 120 is received from the first terminal 110, the communication server 130 sends the message to the second terminal 120.

Furthermore, the communication server 130 may enable the database to be updated with information about an editable visual object generated by the first terminal 110 in synchronization with the first terminal 110 in real time, and may send synchronization information to other terminals being synchronized with the first terminal 110 so that the terminals are updated with the generated editable visual object.

As described above, the communication server 130 may intermediate messages between a plurality of users, may store and manage editable visual objects generated by a plurality of users, and may send changed information to the terminals of other users so that the newest editable visual object is managed by the database of each of the terminals.

FIG. 2 is a block diagram of the communication device according to an embodiment of the present invention.

FIG. 2 illustrates an embodiment of the communication device 200 that may be mounted on the user terminals 110 and 120 of FIG. 1. The communication device 200 is described in more detail with reference to FIG. 2.

As illustrated in FIG. 2, the communication device 200 may include an interface unit 210, an intention input unit 220, a visual object processing unit 230, a message management unit 240, and a database management unit 250.

The interface unit 210 outputs the interface to the user terminal The interface may support various functions through which a user may input his or her intention and edit a recommended editable visual object.

For example, various graphic objects may be output to the interface so that a user inputs his or her intention through text, a voice, an image, or a touch input. That is, a text box may be output to the interface so that the user inputs his or her intention in text. Furthermore, a voice input object operative to receive a voice input requested by a user may be output to the interface so that the user inputs his or her voice through a microphone. Furthermore, an image input object operative to receive an image input requested by a user so that the user may input an image through the image capture module, such as a camera.

Furthermore, the interface may include an editing area in which an editable visual object recommended in response to a user's intention is output. A user may edit an editable visual object in the editing area using various predetermined methods.

In this case, when the user edits a recommended editable visual object in the editing area, the interface unit 210 may output a process of the recommended editable visual object being edited. That is, whenever the user modifies information about the editable visual object, the interface unit 210 may show a process of the editable visual object being modified by outputting an editable visual object corresponding to the modified information in real time.

When a user inputs his or her intention through the interface using various methods as described above, the intention input unit 220 may receive the user's intention so that the visual object processing unit 230 and the message management unit 240 may perform subsequent procedures.

When the intention input unit 220 receives a user's intention, the visual object processing unit 230 may output a recommended visual object, related to the user's intention, to the interface. Furthermore, when the user edits the recommended visual object output to the interface, the visual object processing unit 230 may generate an edited visual object based on information about the edit. In this case, the visual object processing unit 230 may generate the edited visual object by generating the metadata of the edited visual object.

The message management unit 240 may generate a message including conversational content to be transmitted from a user to a counterpart and the metadata of a generated editable visual object, and may send the generated message to the terminal of the counterpart. In this case, the message management unit 240 may request the communication server to send the generated message to the counterpart terminal by sending the message to the communication server.

When a user generates a new editable visual object, the database management unit 250 may store the new editable visual object in a visual object database, and may maintain the visual object database in the newest state in synchronization with the communication server in real time.

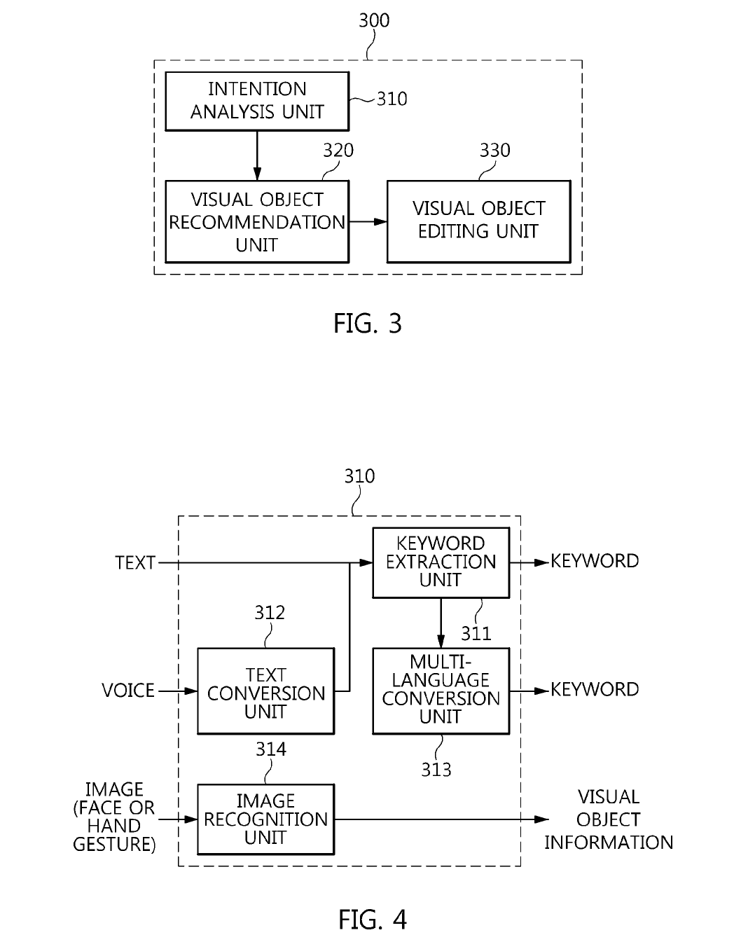

FIG. 3 is a detailed block diagram of the visual object processing unit of the communication device of FIG. 2. FIG. 4 is a detailed block diagram of the intention analysis unit of the visual object processing unit of FIG. 3.

The visual object processing unit 300 according to an embodiment of the present invention is described in more detail with reference to FIGS. 3 and 4.

As illustrated in FIG. 3, the visual object processing unit 300 may include an intention analysis unit 310, a visual object recommendation unit 320, and a visual object editing unit 330.

When a user's intention is received, the intention analysis unit 310 analyzes the user's intention.

The intention analysis unit 310 is described in more detail with reference to FIG. 4. The intention analysis unit 310 may include a keyword extraction unit 311, a text conversion unit 312, a multi-language conversion unit 313, and an image recognition unit 314.

When a user's intention is received in a text form, the keyword extraction unit 311 may extract a keyword operative to search the text for a recommended visual object.

In this case, although text may be input by the user in a keyword form, as in “eye”, “tears,” or “blinking,” it may be possible to make an input in a natural language form, as in “an eye that sheds tears and blinks”.

The keyword extraction unit 311 may determine whether text has been input in a keyword form or a natural language form. If, as a result of the determination, it is determined that the user's intention has been input in a keyword form, the keyword extraction unit 311 may use the input keyword as a keyword operative to search for a recommended visual object. If, as a result of the determination, it is determined that the user's intention has been input in a natural language form, the keyword extraction unit 311 may extract a keyword, such as “tears”, “blinking” or “eye,” using a variety of known analysis techniques.

Furthermore, when a user's intention is input in a voice form, the text conversion unit 312 converts the voice into text. In this case, all known techniques may be applied to a technique for converting the voice into the text.

When a user's voice is converted into text as described above, the keyword extraction unit 311 may extract a keyword from the converted text.

If the extracted keyword is not a predetermined language (e.g., Korean), the multi-language conversion unit 313 may convert the extracted keyword into a keyword in the predetermined language. In this case, the multi-language conversion unit 313 may manage a keyword conversion model among various languages, and may convert the extracted keyword into the keyword in the predetermined language using a corresponding conversion model.

As described above, according to this embodiment of the present invention, a user may perform visual communication with other users regardless of his or her language.

When an image of the face or a hand gesture is received, the image recognition unit 314 may extract information about a predetermined visual object using various face recognition or gesture recognition techniques. In this case, the image recognition unit 314 may extract a predetermined keyword or the ID of the recommended visual object as information about the visual object based on the mouse shape of the face, the facial expression or the hand gesture. In this case, a variety of known techniques may be used as the face recognition or gesture recognition techniques, and detailed descriptions thereof are omitted.

Referring back to FIG. 3, when the intention analysis unit 310 analyzes a user's intention and extracts information, such as a keyword or the ID of a recommended visual object, the visual object recommendation unit 320 may search the visual object database for the visual object to be recommended to the user based on the information, and may provide the retrieved visual object to the user.

When a user edits a recommended visual object, the visual object editing unit 330 may generate the metadata of the edited visual object based on information about the edit. In this case, whenever the user modifies information about the recommended visual object, the visual object editing unit 330 may generate a visual object, corresponding to the modified information, in real time.

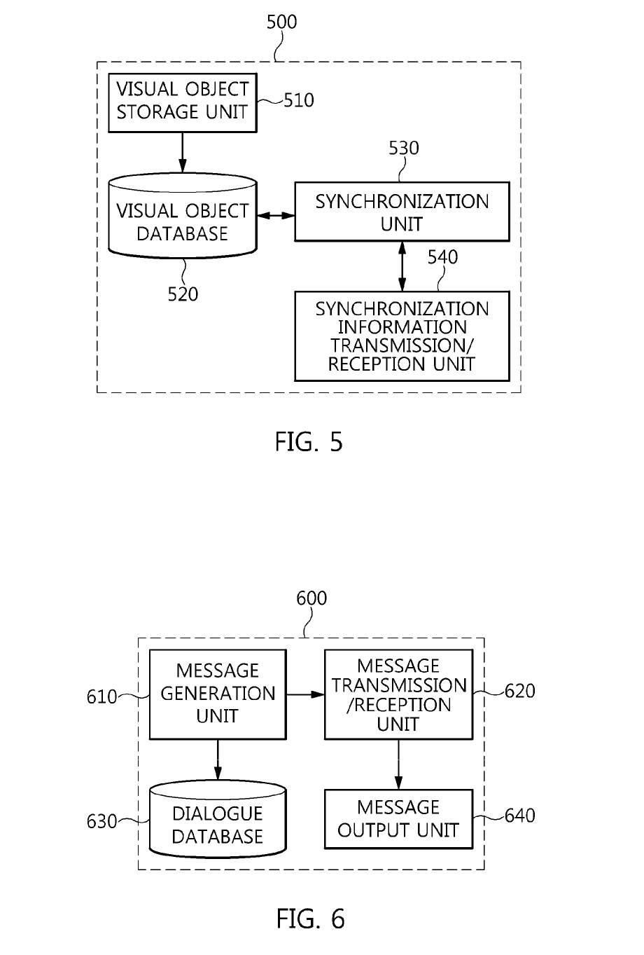

FIG. 5 is a detailed block diagram of the database management unit of the communication device of FIG. 2.

The database management unit 500 according to an embodiment of the present invention is described in more detail with reference to FIG. 5.

As illustrated in FIG. 5, the database management unit 500 may include a visual object storage unit 510, a visual object database 520, a synchronization unit 530, and a synchronization information transmission/reception unit 540.

When a user edits a recommended visual object and thus the metadata of a new visual object is generated, the visual object storage unit 510 stores the metadata of the visual object in the visual object database 520.

The visual object database 520 may store various editable visual objects generated by other users or developers through synchronization with the communication server in addition to visual objects generated by the user.

The synchronization unit 530 may maintain the newest information in the visual object database 520 by sending and receiving synchronization signals to and from the communication server in real time.

For example, when the visual object storage unit 510 stores a new visual object in the visual object database 520, the synchronization unit 530 may generate synchronization information by checking changed content in the visual object database 520 so that the synchronization information transmission/reception unit 540 sends the generated synchronization information to the communication server.

Furthermore, when the synchronization information transmission/reception unit 540 receives synchronization information from the communication server, the synchronization unit 530 incorporates the received synchronization information into the visual object database 520. That is, when other users send new visual objects to the communication server, the communication server may check changed content and send synchronization information including the metadata of newly registered visual objects. The synchronization information transmission/reception unit 540 may receive the synchronization information so that the synchronization unit 530 may update the received synchronization information into the visual object database 520.

FIG. 6 is a detailed block diagram of the message management unit of the communication device of FIG. 2.

The message management unit 600 according to an embodiment of the present invention is described in more detail with reference to FIG. 6. As illustrated in FIG. 6, the message management unit 600 may include a message generation unit 610, a message transmission/reception unit 620, a dialogue database 630, and a message output unit 640.

When a user generates a visual object to be transmitted by editing a recommended visual object, the message generation unit 610 generates a message including the generated visual object. In this case, the message may further include conversational content in a text, voice or image form in addition to the visual object to be transmitted from the user to a counterpart. The user may input the conversational content to be transmitted to the counterpart along with a user's intention using various functions provided by the interface, as described above.

The message generation unit 610 may store a message, generated as described above, in the dialogue database 630, and may manage conversational content. Furthermore, the message generation unit 610 may recommend previously generated conversational content to a user while referring to the dialogue database 630 in response to a request from the user so that the user may reuse similar conversational content.

When the message generation unit 610 generates a message, the message transmission/reception unit 620 may send the message to the communication server. The message transmitted to the communication server as described above may be transmitted to a counterpart terminal and output.

Furthermore, the message transmission/reception unit 630 may receive the message of a counterpart terminal from the communication server.

When the message of a counterpart terminal is received from the communication server, the message output unit 640 may output the message to the interface so that the message is provided to a user. The message output unit 640 may store a received message in the dialogue database 630 so that the dialogue database 630 may manage a history of dialogues.

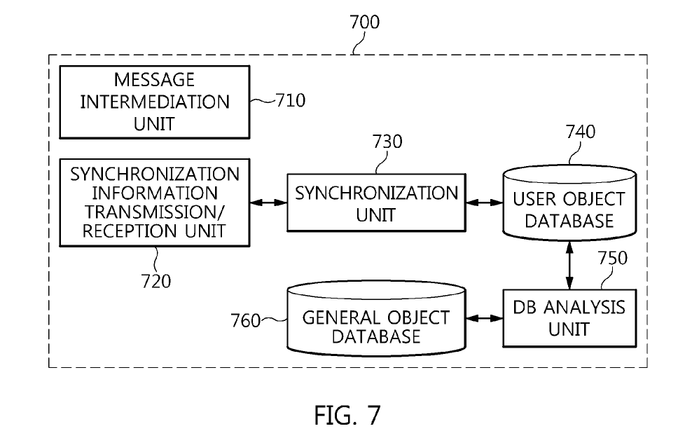

FIG. 7 is a block diagram of a communication server according to an embodiment of the present invention.

Referring to FIG. 7, the communication server 700 may include a message intermediation unit 710, a synchronization information transmission/reception unit 720, a synchronization unit 730, a user object database 740, a DB analysis unit 750, and a general object database 760.

When a message is received from any terminal, the message intermediation unit 710 may send the received message to a counterpart terminal

The synchronization information transmission/reception unit 720 may receive synchronization information from the communication device of a terminal, may send the synchronization information to the synchronization unit 730, and may send synchronization information generated by the synchronization unit 730 to the communication device of the terminal in synchronization with the communication device of the terminal.

When the synchronization information transmission/reception unit 720 receives synchronization information from a terminal, the synchronization unit 730 updates the user object database 740 with information about a visual object for the user of the terminal In this case, the user object database 740 stores and manages the visual objects of users who exchange messages using the communication server 700.

Furthermore, when information about the visual object of the user of the terminal is updated, the synchronization unit 730 may determine whether or not information about the visual objects of other terminal users needs to be updated, and may generate synchronization information to be transmitted to a terminal whose visual object needs to be updated so that the synchronization information transmission/reception unit 720 may send the generate synchronization information to the terminal whose visual object needs to be updated.

The DB analysis unit 750 may analyze the user object database 740 in which visual objects are managed based on each user, and may determine whether or not new visual objects are visual objects that need to be managed as basic templates when the new visual objects are stored. If, as a result of the determination, it is determined that the new visual objects are visual objects that need to be managed as the basic templates, the DB analysis unit 750 may store the new visual objects in the general object database 760.

In this case, the general object database 760 may store visual objects, generated by a user and added as a basic template by the DB analysis unit 750, in addition to the templates of editable visual objects previously generated by developers.

The general object database 760 for managing the templates of various visual objects as described above may be used to provide the visual objects to new users who will use communication service in the future or may be used for various other services.

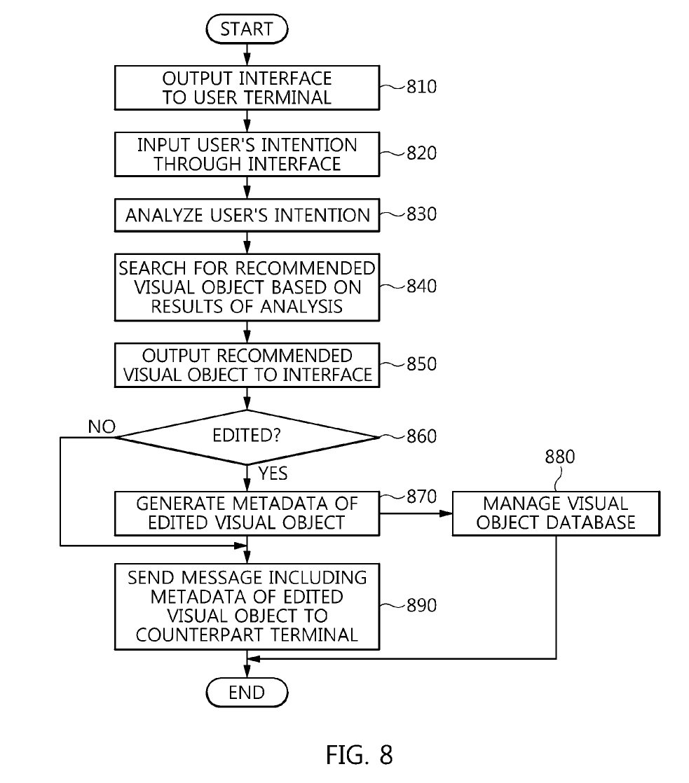

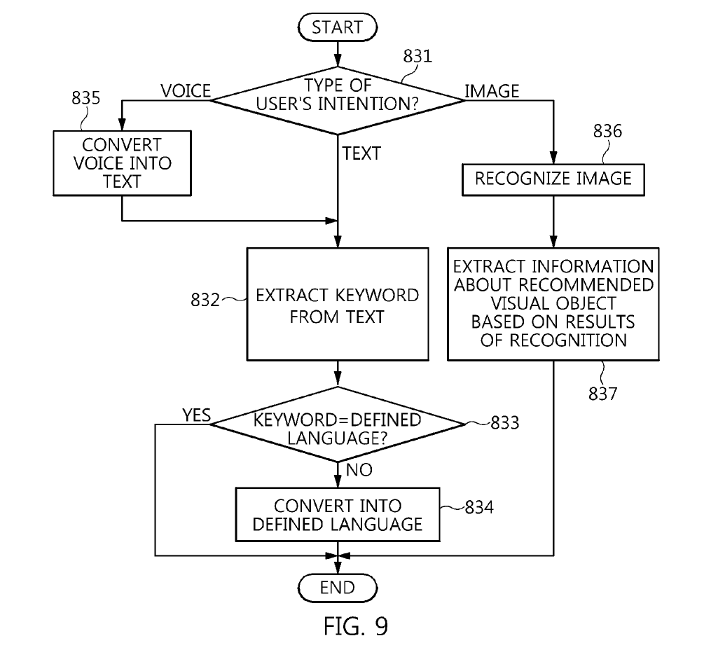

FIG. 8 is a flowchart illustrating a communication method according to an embodiment of the present invention. FIG. 9 is a detailed flowchart illustrating the intention analysis process of the communication method of FIG. 8.

FIGS. 8 and 9 may illustrate embodiments of the communication method that is performed by the communication device 200 of FIG. 2. Although the embodiments of the communication method that is performed by the communication device 200 have been described in detail above, these embodiments are described in brief

Referring to FIG. 8, the communication device 200 outputs the interface to the terminal of a user at step 810. In this case, the interface may provide support so that the user's intention may be received using various methods, such as text, voice or an image, and may provide support so that the user may easily edit a recommended editable visual object.

A user's intention is received from the user through the interface at step 820. In this case, the user's intention may be received in a text, voice or image form.

The communication device 200 may extract information about a keyword or a recommended visual object from the user's intention by analyzing the received user's intention at step 830.

Step 830 of analyzing the user's intention is described in more detail with reference to FIG. 9. First, the communication device 200 may determine the type of received user's intention at step 831.

If, as a result of the determination at step 831, it is determined that the type of received user's intention is text, the communication device 200 may extract a keyword from the text at step 832. In this case, if the user has input the text in a keyword form, the input keyword may be used without changes. If the user has input the text in a natural language form, the keyword may be extracted using various analysis techniques.

The communication device 200 may determine whether or not the extracted keyword corresponds to a predetermined language (e.g., Korean) at step 833.

If, as a result of the determination at step 833 it is determined that the extracted keyword does not correspond to the predetermined language, the communication device 200 may convert the extracted keyword into the predetermined language at step 834.

If, as a result of the determination at step 831, it is determined that the type of received user's intention is a voice, the communication device 200 may convert the voice into text at step 835.

Thereafter, step 832 of extracting the keyword from the converted text to step 834 of converting the extracted keyword into the predetermined language are performed.

If, as a result of the determination at step 831, it is determined that the type of received user's intention is an image, the communication device 200 recognizes the image at step 836. In this case, if the received image is a face image, the communication device 200 may perform face recognition using various known face recognition techniques. If the received image is an image of a hand gesture, the communication device 200 may perform gesture recognition using various known gesture recognition techniques.

The communication device 200 may extract information about a recommended visual object, for example, the ID of the recommended visual object and a keyword based on the results of the recognition at step 837.

Referring back to FIG. 8, when information about a keyword or a recommended visual object is extracted by analyzing the user's intention at step 830, the communication device 200 may search the visual object database 520 for the recommended visual object at step 840, and may output the retrieved recommended visual object to the interface at step 850.

When the user edits the recommended visual object in the interface at step 860, the communication device 200 may generate the metadata of the edited visual object based on information about the edit of the user at step 870.

When the metadata of the edited visual object is generated, the communication device 200 may store the metadata of the edited visual object in the visual object database 520 and manage the visual object database 520 at step 880.

In this case, at step 880 of managing the visual object database 520, when information stored in the visual object database is changed, the communication device 200 may generate synchronization information, and may send the synchronization information to the communication server. When synchronization information is received from the communication server, the communication device 200 may incorporate the received synchronization information into the visual object database 520.

The communication device 200 may generate a message including the metadata of the visual object and send the message to a counterpart terminal via the communication server at step 890. In this case, the message may further include conversational content to be transmitted by the user in addition to the metadata of the visual object.

As described above, according to the present invention, visual objects suitable for situations are recommended to users by recognizing the visual object use patterns, text, voices and images of the users. Accordingly, people who use even different languages can smoothly communicate with each other because users can edit visual objects according to their intentions and use the edited visual objects for communication.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A communication device, comprising:
an intention input unit configured to receive a user's intention through an interface;
a visual object processing unit configured to output a recommended visual object related to the user's intention to the interface, and to generate metadata of an edited visual object when the user edits the recommended visual object through the interface; and
a message management unit configured to send a message, including the generated metadata of the visual object, to a counterpart terminal.

2. The communication device of claim 1, wherein the intention input unit receives the user's intention in at least one of text, voice, touch and image forms through the interface.

3. The communication device of claim 1, wherein the visual object processing unit comprises:
an intention analysis unit configured to analyze the received user's intention; and
a visual object recommendation unit configured to search a visual object database for the recommended visual object based on results of the analysis of the user's intention, and to output the recommended visual object to the interface.

4. The communication device of claim 3, wherein the intention analysis unit comprises:
a text conversion unit configured to convert a voice into text when the user's intention is received in a voice form; and
a keyword extraction unit configured to extract a keyword by analyzing text when the user's intention is received in a text form or when the voice is converted into the text by the text conversion unit.

5. The communication device of claim 4, wherein the intention analysis unit further comprises a multi-language conversion unit configured to convert the extracted keyword into a predetermined language when the extracted keyword does not corresponds to the predetermined language.

6. The communication device of claim 3, wherein the intention analysis unit comprises an image recognition unit configured to extract information about the recommended visual object by recognizing a received image when the user's intention is received in an image form.

7. The communication device of claim 1, further comprising an interface unit configured to output the interface to a terminal of the user, and to output a process of the recommended visual object being edited to the interface in response to an editing operation while the user performs the editing operation on the interface.

8. The communication device of claim 1, further comprising a database management unit configured to store the metadata in a visual object database when the metadata of the visual object is generated.

9. The communication device of claim 8, wherein the database management unit sends synchronization information to a communication server when a change is generated in the visual object database, receives the synchronization information of the editable visual object from the communication server, and incorporates the received synchronization information into the visual object database.

10. A communication method, comprising:
receiving a user's intention through an interface;
outputting a recommended visual object related to the user's intention to the interface;
generating metadata of an edited visual object when the user edits the recommended visual object through the interface; and
sending a message, including the generated metadata of the visual object, to a counterpart terminal.

11. The communication method of claim 10, further comprising:
analyzing the received user's intention when the user's intention is received; and
searching a visual object database for the recommended visual object based on results of the analysis of the user's intention.

12. The communication method of claim 11, wherein analyzing the received user's intention comprises:
determining a type of the received user's intention;
converting a voice into text if, as a result of the determination, it is determined that the type of received user's intention is a voice; and
extracting a keyword by analyzing text if, as a result of the determination, it is determined that the type of received user's intention is text or when the voice is converted into the text upon converting the voice into the text.

13. The communication method of claim 12, wherein analyzing the received user's intention comprises converting the extracted keyword into a predetermined language when the extracted keyword does not correspond to the predetermined language.

14. The communication method of claim 12, wherein analyzing the received user's intention comprises extracting information about the recommended visual object by recognizing a received image if, as a result of the determination, it is determined that the type of received user's intention is the image.

15. The communication method of claim 10, further comprising:
outputting the interface to a terminal of the user; and
outputting a process of the recommended visual object being edited to the interface in response to an editing operation while the user performs the editing operation in the interface.

16. The communication method of claim 10, further comprising storing the metadata in a visual object database when the metadata of the visual object is generated.

17. The communication method of claim 16, further comprising:
sending synchronization information to a communication server when a change is generated in the visual object database;
receiving the synchronization information of the editable visual object from the communication server; and
incorporating the received synchronization information into the visual object database.
